(19) United States
(12) Patent Application Publication
(10) Pub. No.: US 2026/0241353 A1
(43) Pub. Date: Aug. 20, 2026

(54) PADDLE MIXING DEVICE AND METHOD FOR THE CLEANING THEREOF

(71) Applicant: Bühler AG, Uzwil (CH)

(72) Inventors: Marco OTERO, St. Gallen (CH); Frieder Sorbas KLEIN, Tägerwilen (CH)

(73) Assignee: Bühler AG, Uzwil (CH)

(21) Appl. No.: 19/161,836

(22) PCT Filed: Feb. 21, 2024
(86) PCT No.: PCT/EP2024/054441

§ 371 Date: Sep. 3, 2025

(30) Foreign Application Priority Data
Mar. 3, 2023 (EP) 23159837.6

(51) Int. Cl. B01F 35/12; B01F 27/70; B01F 35/11; B01F 35/71; B01F 101/00

(52) U.S. Cl. CPC B01F 35/12; B01F 27/70; B01F 35/11; B01F 35/71775; B01F 2101/2805

(57) ABSTRACT

The present invention relates to a paddle mixing device (1), in particular a preconditioner, comprising a cylindrical mixing unit (2) with a shaft arranged in the mixing unit, wherein the shaft has paddles and the mixing unit has a base surface (2b), characterized in that closable openings (2c) are provided in the base surface (2b) for introducing a cleaning device into the mixing unit (2). The present invention further relates to an extruder (7) comprising such a paddle mixing device (1), and a method for cleaning such a paddle mixing device (1).

The present invention relates to a paddle mixing device, in particular a preconditioner, for an extruder for producing food or animal feed.

Extruders are machines in which materials such as polymers, elastomers or protein-containing mixtures can be treated under desired pressure and temperature conditions for the production of foodstuffs including cereals, snacks, animal feed and alternative foodstuffs. A typical extruder comprises at least one extruder screw shaft, each of the extruder screw shafts having a set of extruder screw elements mounted on a support shaft. The extruder screw shafts are housed in a cylinder, which is referred to as a barrel. An extruder usually comprises several barrels connected end to end. Multiple barrels are required to perform the various processes to be carried out in the extruder, such as conveying, kneading, mixing, degassing, dosing, and the like.

Preconditioners are often used in combination with extruders or other apparatus and are used to prepare and mix food and feed.

For this purpose, for example, one or more flours or a concentrate/isolate are treated with water/steam and/or other additives for subsequent extrusion. The materials to be treated are first mixed with water in the pre-conditioner and treated with steam before they enter the extruder.

A suitable pre-conditioner is known, for example, from DE 197 43 470A1. This pre-conditioner comprises a mixing unit and a retention unit, with the mixing unit being arranged above the retention unit. In both units, at least one shaft with paddles arranged thereon is provided to convey material through the corresponding unit. The separation of the mixing unit from the retention unit allows, on the one hand, optimal, intensive mixing of the material at high rotational shaft speeds and, on the other hand, retention in the retention unit under gentle conditions at slow rotational shaft speeds.

After the material has passed through both units, it enters a material inlet of the extruder via a material outlet located at the lower end of the retention unit. A feed screw can be provided to convey the material from the material outlet of the retention unit to the material inlet of the extruder.

In this known preconditioner, the mixing unit and the retention unit are equipped with doors on both sides, which can be folded up to make the interior of the two units accessible for cleaning purposes. This is not yet optimal.

The problem of the present invention was to provide a paddle mixing device that can be cleaned in an advantageous manner.

This problem is solved by the present invention.

In detail, the present invention relates to a paddle mixing device, in particular a preconditioner, comprising a cylindrical mixing unit with a shaft arranged in the mixing unit, wherein the shaft has paddles and the mixing unit has a base surface, characterized in that closable openings are provided in the base surface for introducing a cleaning device into the mixing unit.

The present invention is based on the idea of providing openings in the base surface of a cylindrical unit of a paddle mixing device through which a cleaning device can be introduced into the interior of the unit in order to clean it.

In its simplest form, the paddle mixing device comprises a cylindrical mixing unit. Such mixing units are known and comprise a material inlet through which material can be introduced into the mixing unit. The material inlet is usually arranged in such a way that material can be introduced into the mixing unit with the aid of gravity. A shaft is provided in the mixing unit, which extends over the entire length of the mixing unit and on which paddles are arranged. With the aid of a drive such as an electric motor, the shaft can be set in rotary motion and convey material located in the mixing unit through the mixing unit.

The mixing unit also has one or more additional inlets for introducing a liquid such as water and/or a gas such as water vapor into the mixing unit.

The cylindrical mixing unit also has a base surface that faces away from the side on which the drive is located. This base surface has closable openings for inserting a cleaning device into the mixing unit. It would also be conceivable to provide closable openings in the base surface where the drive is located for inserting a cleaning device into the mixing unit.

There is preferably a round opening with a diameter that allows the insertion of a conventional cleaning device such as a spray lance (for example from the company Kärcher). Such cleaning devices are known and are not the subject of the present invention. The diameter of the opening is preferably in the range of 10-80 mm, preferably in the range of 10-45 mm, more preferably 15 to 30 mm.

According to the invention, the diameter of the opening is Preferably selected in relation to the diameter of a spray lance used for cleaning such that the ratio r (d(opening)/d(spray lance)) is in the range of 4 to >1, preferably 3 to >1, more preferably 2 to >1, and particularly preferably 1.5 to >1. For example, with a lance diameter of 16 mm, a bore diameter of 17 mm could be selected. This prevents too much cleaning fluid from escaping through the opening during a cleaning process.

According to the invention, this opening is preferably provided with a fastening device such as a thread in order to be able to close the opening tightly, for example with a closed screw nut. The opening should be closed during operation of the mixing unit.

Preferably according to the invention, the opening can additionally be closed with a plug, optionally in combination with an O-ring seal. The plug and O-ring seal are preferably made of an elastic material such as rubber.

Preferably according to the invention, the elements for closing the opening(s) can preferably be installed and removed without tools, for example by using blind plugs.

According to one embodiment of the present invention, it is preferred that the base has 2-8, preferably 2-6, more preferably 3-6, and particularly preferably 4 closable openings for inserting a cleaning device. In a conventional design of a shaft with paddles, the interior of the mixing unit is divided into four segments, each of which occupies approximately one quarter of the cross-section of the cylindrical mixing unit. In order to clean the mixing unit completely or optimally, the cleaning device is to be inserted successively into four openings which are assigned to the corresponding segments, wherein one opening respectively opens into each of these segments.

According to one embodiment of the present invention, it is preferable for safety reasons that the base surface is covered with a cover. In this way, the closable openings arranged in the base surface are concealed from the outside and cannot, for example, be opened accidentally during operation.

According to a preferred embodiment of the present invention, the opening(s) have a length such that even if the relevant opening is not closed, it is not possible to reach through the opening to a shaft rotating during operation (ISO 13857). Monitoring of open openings is then not necessary.

According to a preferred embodiment of the present invention, a cylindrical retention unit with a shaft arranged in the retention unit is additionally provided with the mixing unit, wherein the shaft has paddles and the retention unit has a base surface, wherein the retention unit is preferably arranged below the mixing unit, wherein closable openings are provided in the base surface of the cylindrical retention unit for introducing a cleaning device into the retention unit.

Retention units are known from conventional preconditioners, as described above. A shaft is provided in the retention unit, which extends over the entire length of the retention unit and on which paddles are arranged. With the aid of a drive such as an electric motor, the shaft can be set in rotary motion and convey material located in the retention unit through the retention unit.

In a pre-conditioner described above, the material is transferred to a separate retention unit after leaving the mixing unit. According to the invention, the mixing unit and the retention unit are preferably arranged one above the other, with the mixing unit above the retention unit, in order to transfer the material from the mixing unit to the retention unit with the aid of gravity.

According to the invention, the mixing unit and the retention unit are preferably connected to each other by a closed line, which is preferably arranged at the end of the mixing unit that is furthest away from the material inlet. In this way, the material is first conveyed through the entire length of the mixing unit and processed there before being transferred through the line into the retention unit.

The above statements regarding the openings of the mixing unit also apply analogously to the retention unit, i.e., the information on the number and position of the openings, their diameter, closability, and pluggability, as well as the covering of the openings with a cover, apply analogously.

The retention unit also has a material outlet. This is preferably located on the underside of the retention unit so that the material can be transferred from the retention unit into a feed screw unit or directly into the extruder with the aid of gravity.

According to the invention, the retention unit and the feed screw unit or extruder are preferably connected to each other by a closed line, which is preferably located at the end of the retention unit that is furthest away from the connecting line to the mixing unit. In this way, the material is first conveyed through the entire length of the retention unit and processed there before being transferred through the line into the feed screw unit or the extruder.

According to the invention, there is additionally provided a cylindrical feed screw unit connected to the retention unit with a shaft arranged in the feed screw unit, wherein the shaft has paddles and the feed screw unit has a base surface, wherein the feed screw unit is preferably arranged below the retention unit, wherein closable openings are provided in the base surface of the cylindrical feed screw unit for introducing a cleaning device into the feed screw unit.

Feed screw units are known from conventional extruders with preconditioners. A shaft is provided in the feed screw unit, which extends over the entire length of the feed screw unit and on which paddles are arranged. With the aid of a drive such as an electric motor, the shaft can be set in a rotary motion and convey material located in the feed screw unit through the feed screw unit.

The above statements regarding the openings of the mixing unit also apply to the feed screw unit, i.e., the information on the number and position of the openings, their closability and pluggability, and the covering of the openings with a cover apply analogously.

The feed screw unit also has a material outlet. This is preferably located on the underside of the feed screw unit so that the material can be transferred from the feed screw unit into the extruder with the aid of gravity.

According to the invention, the feed screw unit and the extruder are preferably connected to each other by a closed line, which is preferably arranged at the end of the feed screw unit that is furthest away from the connecting line to the retention unit.

According to the invention, a bypass is preferably arranged on the feed screw unit, which can be opened and closed by means of a flange plate arranged coaxially with the shaft provided in the feed screw unit.

A bypass is known. A bypass serves to initially convey product out of the device via a bypass outlet rather than into the product stream when the device is started up. In this way, material that is formed when the device is started up but does not yet meet the product specifications can be removed from the device in order to prevent contamination.

If the bypass is arranged at the feed screw unit in accordance with the present invention, the pre-conditioning of the product can continue even in the event of a malfunction of the down-stream extruder; the pre-conditioned product is then fed through the bypass outlet into a container.

In a conventional bypass, the bypass outlet is closed by a slide plate, which can preferably be moved pneumatically back and forth horizontally. The slide and the bypass outlet are usually located below the material inlet. However, due to the cylindrical shape of the feed screw unit and the therefore necessarily curved shape of the slide plate, dead spaces are formed in which material can accumulate in larger quantities. This is undesirable for reasons of product safety. Cleaning and sealing this bypass is also difficult.

According to a preferred embodiment of the present invention, the bypass is opened and closed by a flange plate arranged coaxially with the shaft provided in the feed screw unit. In other words, in this preferred embodiment, the bypass is opened and closed by moving a flange plate from a first position in the feed screw unit to a second position in the feed screw unit.

In the first position, the flange plate is located between the material inlet and the bypass outlet and divides the interior of the feed screw unit into two separate sections, with the bypass outlet located in one section and the material inlet and the remaining interior of the feed screw unit located in the other section. Product introduced through the material inlet cannot enter the bypass outlet because the flange plate separates the interior of the feed screw unit into two separate sections that are not fluidically connected to each other.

In the second position, the flange plate separates the interior of the feed screw unit into two other separate sections, with at least part of the bypass outlet and the material inlet located in one section. Product introduced through the material inlet can now enter the bypass outlet.

The flange plate can be moved from the first to the second position by conventional means. Preferably, the flange plate is moved by one or more pneumatic cylinders.

This flange plate, which is arranged coaxially with the feed screw shaft, prevents dead spaces.

The flange plate can preferably be provided with seals such as O-rings made of an elastic material such as rubber.

When the device is started up, the flange plate is moved axially away from the material inlet into the second position described above. The feed screw is operated in reverse and the material introduced is conveyed into the accessible bypass outlet. As soon as the desired product specifications are achieved, the flange plate is moved back to the first position and separates the material inlet from the bypass outlet. The feed screw is operated forward, and material is conveyed into the extruder.

The bypass with flange plate according to the invention can generally be used for any paddle mixing device, in particular any preconditioner or extruder, and is not limited to the present device.

The paddle mixing device according to the invention, in particular preconditioner, can be arranged on any conventional extruder.

The present invention therefore also relates to an extruder comprising a paddle mixing device according to the invention described above, in particular preconditioner.

Extruders are well known. Reference is made, for example, to WO 2012/158023 A1 or to the extruders, in particular twin-screw extruders, from Bühler. Such extruders preferably have an L/D ratio (total length to screw diameter) in the range of 12 to 60, preferably 20 to 40. According to the invention, the extruders are preferably operated at 100 to 1000 rpm, particularly preferably at 200 to 600 rpm, and most preferably at 250 to 350 rpm.

The extruder according to the invention comprises a motor with a gearbox to drive the extruder screws. For this purpose, the drive shaft of each extruder screw is operatively connected to the gearbox. This can be done in a conventional manner.

The extruder according to the invention further comprises an extruder housing with a process zone located in the housing and an inlet and outlet. The extruder housing preferably comprises 2 to 20 barrels, more preferably 2 to 15 barrels. The barrels are preferably connected to each other at the front and together form the extruder housing.

The extruder housing (respectively each of the barrels forming the extruder housing) has a through-bore. The through-bore runs axially through the extruder housing over its entire length. The process zone of the extruder is located within this through-bore.

The extruder housing is preferably temperature-controlled. The material to be extruded is kneaded under pressure (usually 1 to 400 bar, preferably 1 to 200 bar) to form a homogeneous mixture. This usually requires an energy input of 10 to 150 Wh/kg, preferably 10 to 120 Wh/kg, and particularly preferably 15 to 30 Wh/kg.

The inlet of the extruder is used to feed raw materials into a first section of the extruder. This inlet opens into the process zone. The inlet is usually and preferably located on top of the extruder housing so that material can enter the extruder housing, more precisely the process zone of the extruder, under the influence of gravity.

According to the invention, the inlet of the extruder is connected to the preconditioner described above, either to the material outlet of the retention unit or to the material outlet of the feed screw unit (if present).

The material to be extruded can be fed directly into the process zone through the inlet. Preferably, a metering device is located above the inlet, with which the material to be extruded is metered and, optionally, mixed before it is fed through the inlet. According to the invention, the material to be extruded can preferably be pretreated in a conventional preconditioner and fed therefrom, for example by means of a conventional feed screw, to the inlet.

At the end of the process zone remote from the inlet, there is an outlet through which the extruded material leaves the extruder. The outlet is connected to the process zone.

The extruder typically also has a water supply line, an oil supply line, and, optionally, a steam supply line.

According to a preferred embodiment of the present invention, a cooling tool such as a cooling die may be provided at the outlet of the extruder. Cooling tools for extruders are well known. A known distribution unit may preferably be arranged between the extruder and the cooling tool.

The present invention further relates to a method for cleaning a paddle mixing device according to the above description, comprising the steps:
opening a closable opening in a base surface of at least one unit selected from the group consisting of the mixing unit, the retention unit, and the feed screw unit;
inserting a cleaning device into the opened opening (2c, 3c, 4c);
cleaning the at least one unit (2, 3, 4) with the inserted cleaning device.

The method can be carried out with any closable opening (and is preferably carried out with every opening) which is arranged on the unit. For example, the mixing unit, the retention unit and the feed screw unit of the paddle mixing device according to the invention can be cleaned simultaneously or sequentially, in particular through all openings arranged thereon.

Optionally, before introducing a cleaning device into one of the openings, a shaft located in the unit to be cleaned must be moved to a position in which it does not obstruct the introduction of the cleaning device into the unit to be cleaned. If necessary, the shaft can be moved into the desired position by means of the unit's motor or manually, for example with the aid of a tool such as a screwdriver that can be inserted into a hole in the shaft.

Preferably according to the invention, a liquid is fed into the unit to be cleaned by the cleaning device, which is at a pressure exceeding normal pressure. Preferably, this is pressurized water.

For cleaning, a closable opening on one of the units (mixing unit, retention unit, feed screw unit) is opened. In a preferred embodiment of the present invention, the opening is closed with a closed screw nut (nut) or knurled nut, which is loosened from a thread (manually or with the aid of known tools) to open the opening. If there is a plug in the opening, it must also be removed.

The cleaning device, for example a commercially available cleaning lance, is inserted into the opening. According to the invention, it is preferred that the cleaning device has a tube whose length corresponds to the axial extension of the unit to be cleaned. With such a cleaning device, the corresponding unit can be cleaned over its entire axial extension.

Once the cleaning device has been inserted, cleaning is carried out in the usual manner by introducing cleaning fluid.

The process is repeated with each desired opening as required.

In order to remove the cleaning fluid introduced into the unit to be cleaned from the paddle mixing device according to the invention, the bypass is preferably opened, which, as described above, is preferably arranged at the feed screw unit. The cleaning fluid can then be discharged from the paddle mixing device through the bypass outlet.

The present invention is described in more detail below with non-limiting embodiments with reference to the figures. In the figures, the same reference numerals denote the same elements.

The figures show:

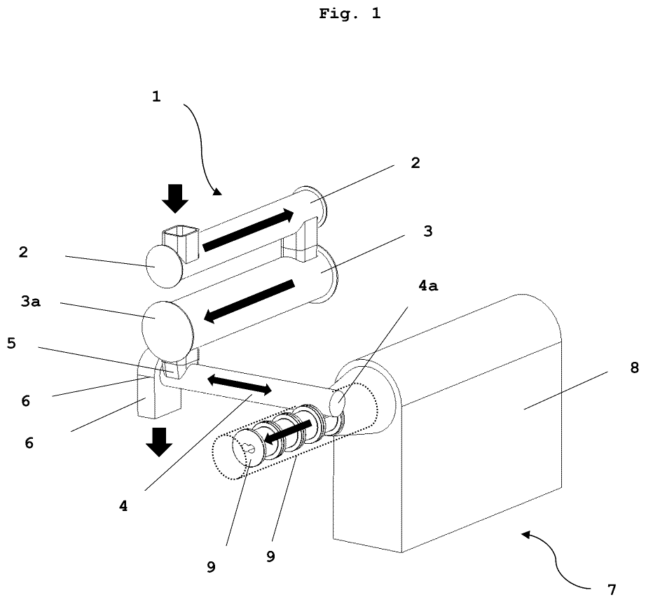

FIG. 1 a Schematic View of an Embodiment of an Extruder With a paddle mixing device according to the invention

FIG. 2 a schematic view of an embodiment of a unit according to the invention with openings located in the base surface

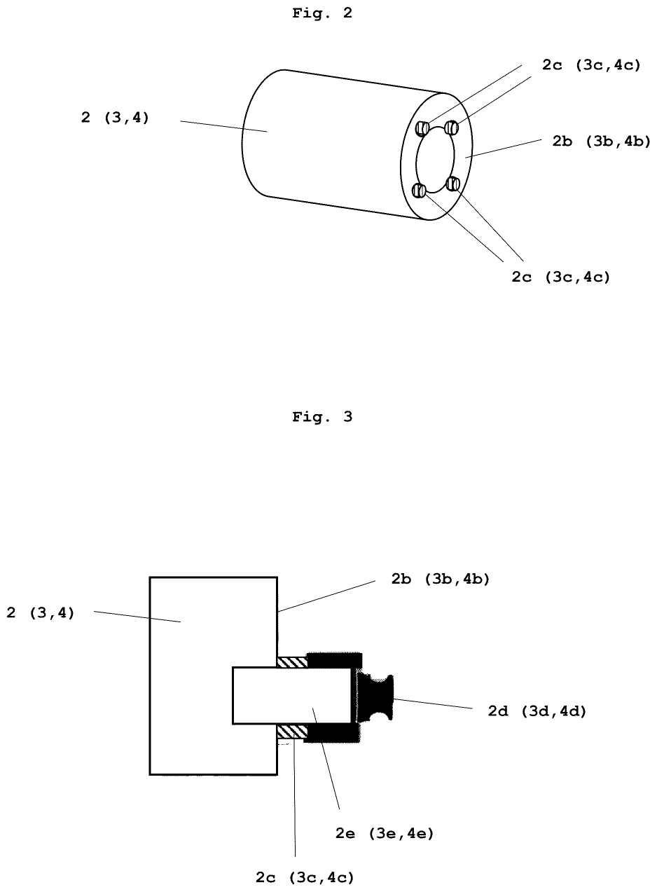

FIG. 3 a schematic view of an embodiment of a unit according to the invention with a closed opening

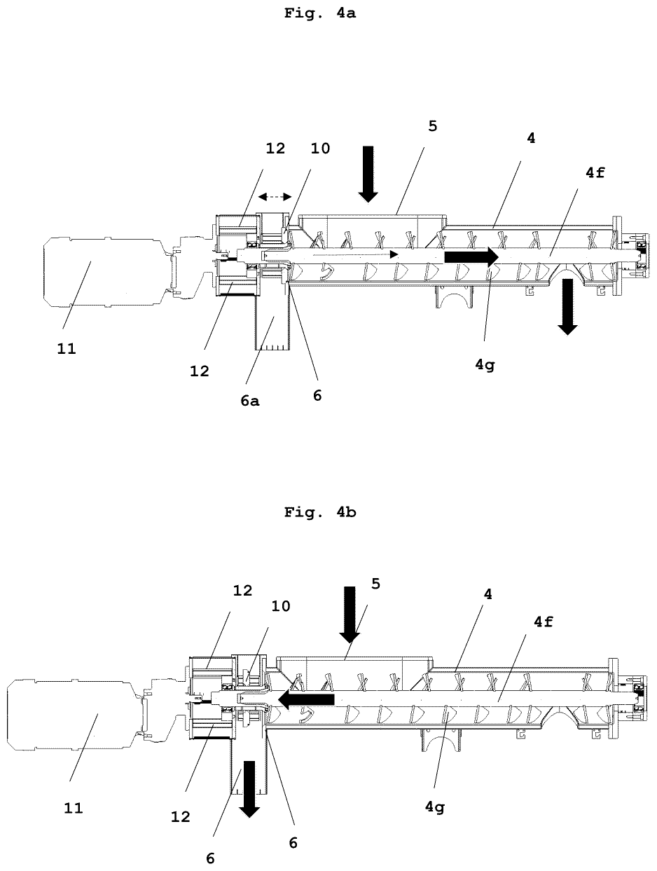

FIG. 4a a schematic view of an embodiment of a bypass according to the invention in the closed state

FIG. 4b A schematic view of an embodiment of a bypass according to the invention in the open state,

FIG. 1 shows a schematic view of an embodiment of an extruder 7 according to the invention with a paddle mixing device 1. The product flow through the device is indicated by black arrows.

The paddle mixing device 1 comprises a cylindrical mixing unit 2 with a material inlet arranged on the mixing unit 2. The base surface 2b (FIG. 2) of the mixing unit 2 is covered with a cover 2a. A shaft with paddles (not shown) is arranged in the mixing unit 2, which can be set in rotary motion by means of a drive (not shown).

A cylindrical retention unit 3 is arranged below the mixing unit 2 and is connected to the mixing unit 2 via a line. This line is arranged at the end of the mixing unit 2 remote from the material inlet so that material flows through the entire length of the mixing unit 2 before entering the retention unit 3 through this line with the aid of gravity. The base surface 3b (FIG. 2) of the retention unit 3 is covered with a cover 3a. A shaft with paddles (not shown) is arranged in the retention unit 3, which can be set in rotary motion by means of a drive (not shown).

A cylindrical feed screw unit 4 is arranged below the retention unit 3 and is connected to the retention unit 3 via a material outlet 5. This material outlet 5 is arranged at the end of the retention unit 3 remote from the line from the mixing unit 2, so that material flows through the entire length of the retention unit 3 before it enters the feed screw unit 4 through this line with the aid of gravity. The base surface 4b (FIG. 2) of the feed screw unit 4 is covered with a cover 4a. A shaft 4f with paddles 4g (shown in FIGS. 4a and 4b) is arranged in the feed screw unit 4, which can be set in rotary motion by means of a drive 11 (shown in FIGS. 4a and 4b).

A bypass 6 comprising a bypass outlet 6a is arranged at the end of the feed screw unit 4 facing away from the base surface 4b. A preferred embodiment of this bypass 6 is described below with reference to FIGS. 4a and 4b.

The feed screw unit 4 is fluidically connected to an inlet of the extruder 7 so that material can pass from the feed screw unit 4 into the process zone 9 of the extruder 7. A feed screw 9a is arranged in the process zone 9 (shown in dashed and trans-parent lines) of the extruder 7, which can be set in rotary motion by means of the drive 8 of the extruder 7 in order to convey material through the process zone 9. Further details of the extruder 7 are known and are not shown in FIG. 1.

FIG. 2 shows a schematic view of an embodiment of a unit 2, 3, 4 according to the invention with openings 2c, 3c, 4c located in the base surface 2b, 3b, 4b. The discussions apply equally to a mixing unit 2, a retention unit 3, and a feed screw unit 4.

In the base surface 2b, 3b, 4b (i.e., the bottom surface of the cylindrical unit 2, 3, 4), in the embodiment shown in FIG. 2, four openings 2c, 3c, 4c are arranged such that each of the openings 2c, 3c, 4c provides access to a region of the unit 2, 3, 4. This region corresponds to one quarter of the cross-sectional area of unit 2, 3, 4. If a cleaning device (not shown) is inserted successively into each of the openings 2c, 3c, 4c, the unit 2, 3, 4 can be completely cleaned.

According to the preferred embodiment shown in FIG. 2, the openings 2c, 3c, 4c protrude from the base surface 2b, 3b, 4b and have a fastening element, such as a thread, in this protruding section. A screw nut 2d, 3d, 4d, for example, can be applied to this thread, as described in FIG. 3.

FIG. 3 shows a schematic view of an embodiment of a unit 2, 3, 4 according to the invention with a closed opening 2c, 3c, 4c. The discussions apply equally to a mixing unit 2, a retention unit 3, and a feed screw unit 4 and all openings 2c, 3c, 4c arranged thereon.

In the embodiment shown in FIG. 3, an opening 2c, 3c, 4c arranged on the base surface 2b, 3b, 4b of the unit 2, 3, 4 4c has a thread in a region protruding from the base surface 2b, 3b, 4b, to which a screw nut 2d, 3d, 4d is fastened. A plug 2e, 3e, de is also provided in the opening 2c, 3c, 4c to close the opening 2c, 3c, 4c. The plug 2e, 3e, 4e may be provided with an O-ring seal (not shown).

FIG. 4a shows a schematic view of an embodiment of a bypass 6 according to the invention in the closed state.

Material enters the feed screw unit 4 through the material outlet 5. A shaft 4f with paddles 4g provided thereon is rotatably arranged in the feed screw unit 4. The shaft 4f with paddles 4g shown in FIG. 4a corresponds analogously to the shafts with paddles arranged in the mixing unit 2 and the retention unit 3.

The shaft 4f can be rotated by means of a drive 11.

A bypass 6 is arranged between the drive 11 and the material outlet 5. The bypass 6 comprises a bypass outlet 6a through which material can be discharged from the feed screw unit 4 as required, without reaching the extruder 7.

The bypass 6 further comprises a flange plate 10, which is arranged coaxially with the shaft 4f in the feed screw unit 4 and can be moved to the left and back again by means of (in FIGS. 4a and 4b, two) pneumatic cylinders, in accordance with the dashed double arrow.

In FIG. 4a, the flange plate 10 is in a position in which it blocks access to the bypass outlet 6a. The shaft 4f is driven forward in the direction (indicated by the dotted arrow) toward the extruder 7. Material entering the feed screw unit 4 through the material outlet 5 is conveyed toward the extruder 7 in accordance with the thick arrows.

In FIG. 4b, the flange plate 10 is in a position in which it allows access to the bypass outlet 6a. The flange plate 10 has been moved to the left relative to FIG. 4a by means of the pneumatic cylinders 12. The shaft 4f is driven backwards in the direction (indicated by the dotted arrow) towards the bypass outlet 6a. Material entering the feed screw unit 4 through the material outlet 5 is conveyed towards the bypass outlet 6a in accordance with the thick arrows.

1. A paddle mixing device comprising a cylindrical mixing unit with a shaft arranged in the mixing unit, wherein the shaft has paddles and the mixing unit has a base surface,
wherein closable openings are provided in the base surface for introducing a cleaning device into the mixing unit.

2. The paddle mixing device according to claim 1, wherein a cylindrical retention unit connected to the mixing unit and having a shaft arranged in the retention unit is additionally provided, wherein the shaft has paddles and the retention unit has a base surface, wherein closable openings are provided in the base surface of the cylindrical retention unit for introducing a cleaning device into the retention unit.

3. The paddle mixing device according to claim 2, wherein a cylindrical feed screw unit connected to the retention unit is additionally provided with a shaft arranged in the feed screw unit, wherein the shaft has paddles and the feed screw unit has a base surface, wherein closable openings are provided in the base surface of the cylindrical feed screw unit for introducing a cleaning device into the feed screw unit.

4. The paddle mixing device according to claim 3, wherein in at least one unit selected from the group consisting of the mixing unit, the retention unit and the feed screw unit, a base surface with 2-8 closable openings for introducing a cleaning device is provided.

5. The paddle mixing device according to claim 4, wherein the closable openings are closed with a screw nut.

6. The paddle mixing device according to claim 4, wherein a plug is arranged in the closable openings.

7. The paddle mixing device according to claim 4, wherein a cover is arranged over the closable openings.

8. The paddle mixing device according to claim 3, wherein a bypass is arranged at the feed screw unit, which can be opened and closed by means of a flange plate arranged coaxially with the shaft provided in the feed screw unit.

9. An extruder, comprising a paddle mixing device according to claim 1.

10. A method for cleaning a paddle mixing device according to claim 1, comprising the steps:
opening a closable opening in a base surface of at least one unit selected from the group consisting of the mixing unit, the retention unit and the feed screw unit;
inserting a cleaning device into the opened opening;
cleaning the at least one unit with the inserted cleaning device.

11. The method according to claim 10, wherein the method can be carried out with each closable opening arranged at the unit.

12. The method according to claim 10, wherein a liquid is fed through the cleaning device into the unit to be cleaned, which liquid is at a pressure exceeding normal pressure.

13. The method according to claim 10, wherein the cleaning device has a pipe whose length corresponds to the axial extension of the unit to be cleaned.

14. The method according to claim 10, wherein the bypass is opened in order to discharge the liquid fed into the unit to be cleaned from the paddle mixing device.
